(19) United States
(12) Patent Application Publication
(10) Pub. No.: US 2014/0280451 A1
(43) Pub. Date: Sep. 18, 2014

(54) Method and Apparatus for Mobile Device Connectivity Compatibility Facilitation

(71) Applicant: FORD GLOBAL TECHNOLOGIES, LLC, Dearborn, MI (US)

(72) Inventors: James Dragescu, San Diego, CA (US); Andrei Negrus, New Albany, IN (US)

(73) Assignee: Ford Global Technologies, LLC, Dearborn, MI (US)

(21) Appl. No.: 13/804,589

(22) Filed: Mar. 14, 2013

(51) Int. Cl. H04L 29/08

(52) U.S. Cl. CPC H04L 67/12
USPC 709/202

(57) ABSTRACT

A system includes a processor configured to receive a request for communication between an application executed by the processor and a wirelessly connected vehicle computing system (VCS). The processor is also configured to confirm VCS compatibility with functionality or resources requested by an application originated communication request. The processor is further configured to translate the request to a VCS language or an application language, based on whether the VCS or the application is an intended recipient and pass the translated request to the intended recipient

### TECHNICAL FIELD

The illustrative embodiments generally relate to a method and apparatus for mobile device connectivity compatibility facilitation.

### BACKGROUND

As vehicle infotainment systems continue to provide wireless integration with mobile devices, and as mobile device options continue to grow, there is increasing pressure to ensure that as many devices as possible are compatible with as many vehicle systems as possible.

In any given snapshot of time, there are certainly prevalent mobile devices. Whether it is five, fifteen or fifty devices, strategies for device connectivity to a vehicle infotainment system can be implemented. Unfortunately, due largely to the high turn-over in mobile devices, and the non-standardized platforms, hardware and software configurations provided on the devices, it is difficult to continually stay abreast of changing mobile technology.

Further, updates to infotainment systems can often be difficult to implement. Even if a patch or a fix for a particular device is available, a user may have to utilize a memory reflash to implement the change, which can be confusing. Additionally, the user may not even know that the updated patch or version of an infotainment software module is available.

### SUMMARY

In a first illustrative embodiment, a system includes a processor configured to receive a request for communication between an application executed by the processor and a wirelessly connected vehicle computing system (VCS). The processor is also configured to confirm VCS compatibility with functionality or resources requested by an application originated communication request. The processor is further configured to translate the request to a VCS language or an application language, based on whether the VCS or the application is an intended recipient and pass the translated request to the intended recipient.

In a second illustrative embodiment, a computer-implemented method includes receiving a request for communication between an application on a mobile device and a wirelessly connected vehicle computing system (VCS). The method also includes confirming, via the mobile device VCS compatibility with functionality or resources requested by an application originated communication request. The method further includes translating the request to a VCS language or an application language, based on whether the VCS or the application is an intended recipient and passing the translated request to the intended recipient.

In a third illustrative embodiment, a non-transitory computer-readable storage medium, stores instructions that, when executed by a mobile device processor, cause the processor to perform a method including receiving a request for communication between an application on a mobile device and a wirelessly connected vehicle computing system (VCS). The method also includes confirming, via the mobile device VCS compatibility with functionality or resources requested by an application originated communication request. The method further includes translating the request to a VCS language or an application language, based on whether the VCS or the application is an intended recipient and passing the translated request to the intended recipient.

### BRIEF DESCRIPTION OF THE DRAWINGS

FIG. 1 shows an illustrative vehicle computing system;

FIG. 2 shows a prior art configuration of a system;

FIG. 3 shows an exemplary new system implementing an illustrative embodiment;

FIG. 4 shows a block diagram of new system implementation;

FIG. 5 shows an illustrative example of a communication process;

FIG. 6 shows an illustrative example of a command translation process; and

FIG. 7 shows an illustrative example of command flow process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

FIG. 2 shows a prior art configuration of a system. In the illustrative embodiment shown in FIG. 2, three different parts of a system are controlled by three different suppliers. The VCS/infotainment portion 207 of the system 201, is controlled by the automotive OEM. The OEM can update this platform and provide for compatibility with as many applications and phone as possible.

Next, the phone suppliers control the actual software installed 209 on a given phone 203. This can include applications, menu configurations, and particular configurations of OS's and how data is handled. Finally, the OS providers 205 control the platform on which the phone operates. While reasonably standardized, this can still result in numerous OS's and OS versions deployed over a variety of phones, as OS versions continually improve to match phone capabilities.

The result is that an OEM, who desires compatibility with a given phone, so that a car purchaser is provided with a relatively seamless experience, needs to keep ahead of new phones and new software developments, so that vehicle purchasers remain satisfied. Since vehicle infotainment systems are a selling point for an OEM, it is up to the OEM, oftentimes, to ensure device compatibility.

FIG. 3 shows an exemplary new system implementing an illustrative embodiment. In this illustrative example, the phone manufacturers are removed from the equation. That is, instead of relying on a phone manufacturer to provide communication compatibility, the automotive OEM 301 provides an application 307 that resides on a phone and provides connectivity. These applications can be easily written and configured for a variety of phones, and since they all speak the same outgoing language to the VCS 305, new VCS versions do not need to be written and adapted for compatibility with each phone.

This reduces the number of variables in the equation significantly, and benefits from the fact that there are far fewer versions of a given operating system 309, which is still externally controlled 303, than there are versions of new phones being released. This can reduce the load of compatibility development. Further, these applications are far easier to update, and the updating can often be done automatically any time a phone connection is established with a remote application server.

FIG. 4 shows a block diagram of new system implementation. In this illustrative example, the system has two basic components, a vehicle computing system 401 and a mobile device 403.

The vehicle computing system has an I/O component 507, through which input and output can occur from various sources. In this example, it is considered that input may be provided to the VCS in order to control an application running on the mobile device. In a similar manner, output from the application may be provided to one of a number of possible outputs.

The information from/to the I/O flows to a processor of the VCS 405. Here, in this example, the processor can translate the I/O in a suitable form for delivery to a destination. Since, in this example, the processor “knows” about both possible destinations (i.e., the outputs onboard or the application residing on the mobile device), the processor doesn't have to hand-tailor the transmission for provision to a specific device, or translate variances in incoming transmissions.

Instead, speaking a single “language,” (or one of a few languages) the processor can send the information to a transceiver 409 for transfer to a similar transceiver on the remote device 411. Once the information is received by the remote device, the information passes to the OEM application 413, used for communication with the OEM provided VCS. Similarly, information from applications residing on the mobile device 419 pass through a device CPU 415 and can be sent to the OEM application for translation into the common language. Device I/O 417 can also be passed in this manner.

The OEM application is capable of translating between the OEM “language” and the “language” of any particular device or application on a device. As a device-based software application, compatibility is easier to assure, and updating is greatly facilitated. Through this strategy, it is easier to ensure new device compatibility with an OEM provided VCS.

FIG. 5 shows an illustrative example of a communication process. In this illustrative example, the OEM application receives a request from an application residing on the wireless device 501. The request can include a simple instruction, or it could be an initiation request, for example, identifying a number of resources and other functions that a particular application would like to use.

The OEM application, which speaks the language of the mobile OS, identifies particular resources and other features that an application seeks to utilize by request 503. Once the OEM application has identified the functions and resources, the OEM application determines if the VCS is capable of providing the requested functions and/or resources 505. In this example, the OEM application is not validating the application for the right to use these resources and functions, but merely confirming the capability of the VCS to provide the functionality. In other examples, validation may also occur.

If capabilities are lacking in the VCS, the OEM application will notify the requesting application 507 and then exit. On the other hand, if the resources and/or functions are available (i.e., the VCS can provide the function or resources requested), the OEM application will provide the requested functionality (assuming that validations have been done, if necessary) 509 and notify the application that the request has been processed 511. Further communication can then resume with the requesting application 513, which can continue until such time as all communication has been completed and processed 515.

FIG. 6 shows an illustrative example of a command translation process. In this illustrative example, the OEM application (OEMA) receives a request from the VCS to access an secondary application running on the mobile device 601. The application can be one which previously communicated with the VCS through the OEMA, or it can be an application that is not yet active or that is believed to be on the mobile device.

The OEMA attempts to identify the recipient application 603 in order to communicate with the recipient application. If the recipient application is known 605, the OEMA will attempt to translate the request 607 into a request processable by the recipient application. These requests can include, but are not limited to, application launch, application control, VCS feedback, confirmation messages and other communiqué. If the translation was a success 609 (i.e., if the OEMA was able to put the communication in a form presumably receivable by the recipient application), then the process provides the translation to the recipient application 613. On the other hand, if the translation was unsuccessful 609, the process reports back to the VCS 611. VCS reporting may also occur when the OEMA is unable to identify a recipient for an incoming transmission.

FIG. 7 shows an illustrative example of command flow process. In this illustrative example, the OEMA receives a request 701 from a mobile CPU or application running on the mobile device. The OEMA will do its best to translate the request into a format suitable for receipt by the VCS 703, and pass the translated command/request to the VCS for processing 705.

If the VCS is providing the validation of the application, it may be that the requesting application is not “qualified” to request the requested service/function from the VCS, or the VCS may be otherwise unable to comply. In other instances, the VCS may process the application and provide a return message. In either event, it is likely that some form of response will be returned from the VCS 707.

In this example, the return response will indicate whether or not the requested function/resource was available for access, or if the command was completed 709. If there was a rejection or a failure, the requesting application will be notified 711, often times with an indicia of what caused the problem (e.g., error, invalid access attempt, etc.).

On the other hand, if the request was successfully processed by the VCS, the OEMA will translate the response 717 and pass the response to the application 715. This facilitates communication between the VCS and the requesting app, despite the fact that neither may speak the same “language.” If the application is done with communication 713, the process can exit. Otherwise, the process may continue until all pending communication has been completed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request for communication between an application executed by the processor and a wirelessly connected vehicle computing system (VCS);
confirm VCS compatibility with functionality or resources requested by an application originated communication request;
translate the request to a VCS language or an application language, based on whether the VCS or the application is an intended recipient; and
pass the translated request to the intended recipient.

2. The system of claim 1, wherein the processor is further configured to validate the native application as being qualified to access a requested resource.

3. The system of claim 1, wherein the processor is further configured to validate the native application as being qualified to access a requested function.

4. The system of claim 1, wherein the processor is configured to verify compatibility with functionality by determining if a requested function can be performed by the VCS.

5. The system of claim 1, wherein the processor is configured to verify compatibility with the resources requested by determining if the requested resources can be provided by the VCS.

6. The system of claim 1, wherein the processor is provided as part of a cellular phone.

7. A computer-implemented method comprising:
receiving a request for communication between an application on a mobile device and a wirelessly connected vehicle computing system (VCS);
confirming, via the mobile device VCS compatibility with functionality or resources requested by an application originated communication request;
translating the request to a VCS language or an application language, based on whether the VCS or the application is an intended recipient; and
passing the translated request to the intended recipient.

8. The method of claim 7, further comprising validating the native application as being qualified to access a requested resource.

9. The method of claim 7, further comprising validating the native application as being qualified to access a requested function.

10. The method of claim 7, wherein verifying compatibility with functionality includes determining if a requested function can be performed by the VCS.

11. The method of claim 7, wherein verifying compatibility with the resources includes determining if the requested resources can be provided by the VCS.

12. The method of claim 7, wherein mobile device is a cellular phone.

13. A non-transitory computer-readable storage medium, storing instructions that, when executed by a mobile device processor, cause the processor to perform a method comprising:
receiving a request for communication between an application on a mobile device and a wirelessly connected vehicle computing system (VCS);
confirming, via the mobile device VCS compatibility with functionality or resources requested by an application originated communication request;
translating the request to a VCS language or an application language, based on whether the VCS or the application is an intended recipient; and
passing the translated request to the intended recipient.

14. The computer-readable storage medium of claim 13, further comprising validating the native application as being qualified to access a requested resource.

15. The computer-readable storage medium of claim 13, further comprising validating the native application as being qualified to access a requested function.

16. The computer-readable storage medium of claim 13, wherein verifying compatibility with functionality includes determining if a requested function can be performed by the VCS.

17. The computer-readable storage medium of claim 13, wherein verifying compatibility with the resources includes determining if the requested resources can be provided by the VCS.

18. The computer-readable storage medium of claim 13, wherein mobile device is a cellular phone.
